(19) United States
(12) Patent Application Publication
(10) Pub. No.: US 2005/0140127 A1
(43) Pub. Date: Jun. 30, 2005

(54) System and method for steering wheel adjustment

(75) Inventor: Gikou Nakajima, Tokyo (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/013,344

(22) Filed: Dec. 17, 2004

Related U.S. Application Data
(60) Provisional application No. 60/532,625, filed on Dec. 29, 2003.

(51) Int. Cl. B60R 21/32

(52) U.S. Cl. 280/731; 280/735

(57) ABSTRACT

A system and method for adjustment of a steering wheel position and/or airbag pressurization is disclosed. According to one embodiment, a steering wheel positioning method includes sensing occupant characteristics of an occupant in a seat facing a steering wheel. An inflator control for an airbag in the steering wheel is adjusted based on the occupant characteristics, and the steering wheel is positioned based on the occupant characteristics and the inflator control. In another embodiment, a safety restraint control method includes sensing occupant characteristics of an occupant in a seat facing a steering wheel, and determining a position of the steering wheel. An inflator control for an airbag in the steering wheel is adjusted based on the occupant characteristics and the position of the steering wheel.

### BACKGROUND

The present application claims priority to and benefit of U.S. Provisional Application Ser. No. 60/532,625, filed Dec. 29, 2003.

The present invention relates generally to the field of safety restraint systems. In particular, the invention relates to steering wheel positioning and/or airbag pressurization based on occupant characteristics.

### SUMMARY OF THE INVENTION

According to an embodiment of the present invention, a steering wheel positioning method for a vehicle. The method includes sensing occupant characteristics of an occupant in a seat facing a steering wheel. An inflator control for an airbag in the steering wheel is adjusted based on the occupant characteristics, and the steering wheel is positioned based on the occupant characteristics and the inflator control.

Another embodiment of the present invention provides a steering wheel positioning system for a vehicle. The system includes an occupant characteristics sensing module, an inflator control module and a steering wheel control module. The occupant characteristics sensing module is adapted to determine characteristics of an occupant in a seat facing a steering wheel. The inflator control module is adapted to adjust inflator gas flow rate to an airbag in the steering wheel based on the occupant characteristics. The steering wheel control module is adapted to position the steering wheel based on the occupant characteristics and the inflator gas flow rate.

According to yet another embodiment of the present invention, a safety restraint control method for a vehicle is provided. The method includes sensing occupant characteristics of an occupant in a seat facing a steering wheel, and determining a position of the steering wheel. An inflator control for an airbag in the steering wheel is adjusted based on the occupant characteristics and the position of the steering wheel.

According to a safety restraint control system is provided. The system includes an occupant characteristics sensing module, a steering wheel position module and an inflator control module. The occupant characteristics sensing module is adapted to determine characteristics of an occupant in a seat facing a steering wheel. The steering wheel position module is adapted to determine a position of the steering wheel, and the inflator control module is adapted to adjust inflator gas flow rate to an airbag in the steering wheel based on the occupant characteristics and the position of the steering wheel.

It is to be understood that both the foregoing general description and the following detailed description are exemplary and exemplary only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic illustration of an embodiment of a steering wheel adjustment system according to the present invention;

FIG. 2 is a flow chart illustrating a method for adjusting a steering wheel position;

FIG. 3 is a schematic illustration of an embodiment of a safety restraint control system according to the present invention;

FIG. 4 is a flow chart illustrating a method for adjusting a safety restraint component according to the present invention;

FIGS. 5A and 5B illustrate an embodiment of a belt reacher system for use with the present invention;

FIGS. 6A and 6B illustrate an embodiment of a belt buckle positioning system for use with the present invention;

FIGS. 7A and 7B illustrate another embodiment of a belt buckle positioning system for use with the present invention; and

FIG. 8 illustrates an embodiment of a seatbelt height adjustment system for use with the present invention.

### DETAILED DESCRIPTION

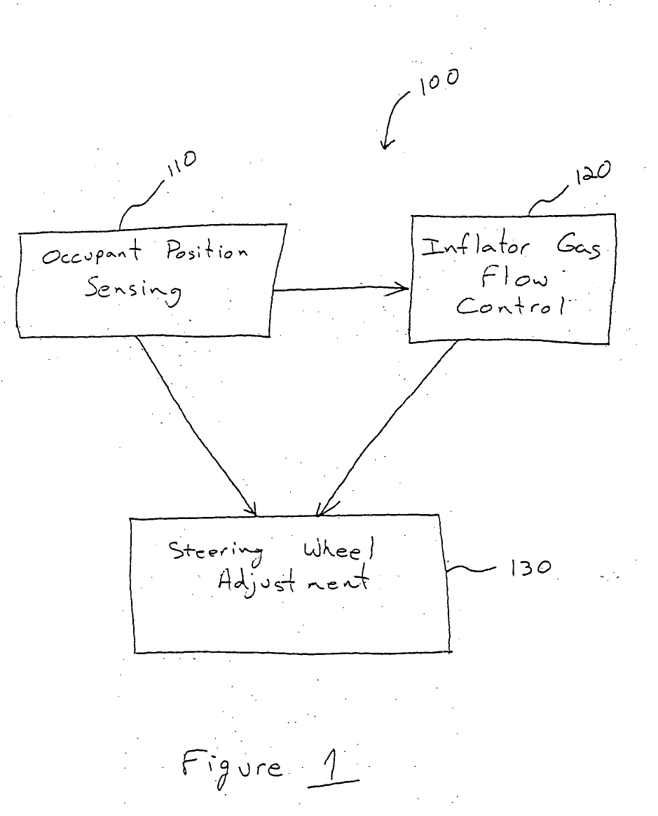

Referring to FIG. 1, an embodiment of a steering wheel adjustment system in a vehicle, such as an automobile, according to the present invention is illustrated. The steering wheel adjustment system 100 includes an occupant sensing module 110. The occupant sensing module 110 is adapted to detect certain characteristics of an occupant of a seat facing the steering wheel of the vehicle. The occupant sensing module 110 may be capable of detecting or measuring such occupant characteristics as the weight of the occupant and the height of the head of the occupant in the seated position. Such occupant sensing modules are well known to those skilled in the art.

One embodiment of such a sensing module is a seat weight sensor (SWS). An SWS system may include one or more sensors positioned along or within the seat and are capable of detecting, measuring or sensing the weight of an occupant in the seat. Another embodiment of a sensing module includes an electric capacity sensor.

In other embodiments, the sensing module includes an image recognition sensor. The image recognition sensor may include one or more of a CCD camera, a CMOS camera, a 3D camera and a stereo camera. One such image recognition sensor is described in U.S. Provisional Patent Application Ser. No. 60/627,027, titled “Vehicle Safety Control System by Image Processing,” filed Nov. 12, 2004, which is hereby incorporated by reference in its entirety.

The occupant sensing module 110 communicates the occupant characteristics to an inflator gas flow control module 120. The inflator gas flow control module 120 controls the flow rate of gas into an airbag during pressurization. For example, in the event of an airbag-deployment event, an airbag housed within the steering wheel or the steering wheel column is deployed by flowing gas into the airbag at a high rate. The inflator gas flow control module 120 controls the gas flow rate based on the occupant characteristics. The gas flow rate may be determined, for example, using a table look up or a set of polynomial coefficients. In one embodiment, the gas flow rate is set at a baseline rate and is adjusted along a substantially continuous set of levels based on the occupant characteristics. For example, the flow rate may be a linear or logarithmic function of the weight of the occupant. In another embodiment, the gas flow rate is adjusted at predetermined, discrete values based on the occupant characteristics. In this regard, the flow rate is stepped to higher or lower levels, each level corresponding to a range of weights for the occupant. In a preferred embodiment, the flow rate is set to a lower rate only when the occupant characteristics indicate that the driver is smaller than a fifth-percentile adult female.

The occupant sensing module 110 and the inflator gas flow control module 120 communicate information to a steering wheel adjustment module 130. In this regard, the occupant sensing module 110 communicates the occupant characteristics, while the gas flow control module 120 transmits the gas flow rate. The steering wheel adjustment module 130 is adapted to cause the steering wheel to be positioned to improve safety based on the adjusted flow rate. The positioning of the steering wheel may include adjustment of the steering angle and/or the extension of the steering column. The steering angle refers to the vertical angle of the steering column, and the extension refers to the protrusion of the steering column into the cab of the vehicle. The steering angle and extension may be determined using, for example, a one- or multi-dimensional table look up or a set of polynomial coefficients.

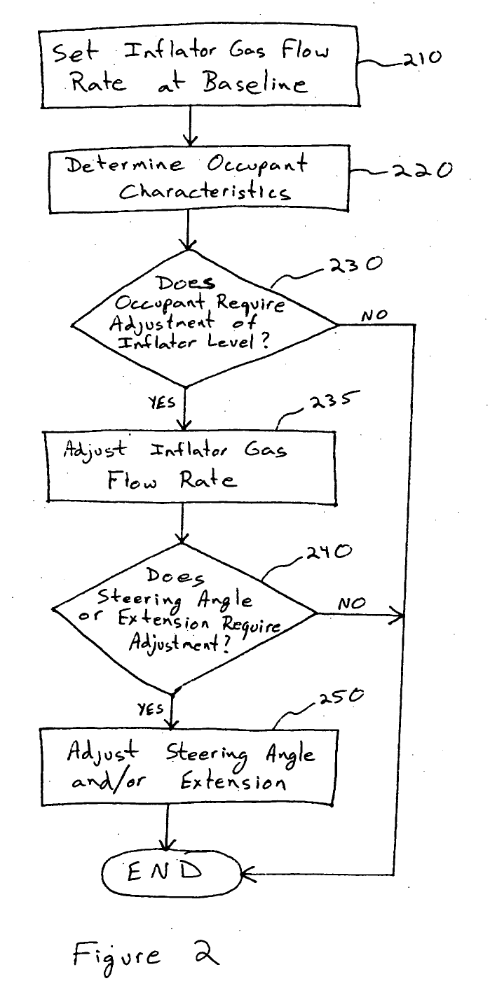

FIG. 2 illustrates the adjustment of the steering angle and/or extension according to an embodiment of the invention. Initially, at block 210, the inflator gas flow rate may be set at a baseline level determined, for example, to be applicable to a majority of the population. At block 220, the occupant characteristics of the occupant of the driver seat are determined. As noted above, the occupant characteristics may include, without limitation, the weight of the occupant and the height of the head of the occupant.

At block 230, a determination is made as to whether or not the occupant characteristics indicate the need to adjust the inflator flow rate level. As described above with reference to FIG. 1, the required flow rate level may be determined through a table lookup or a set of polynomials and may be either continuous or discrete. If no adjustment is required, the process terminates.

If the determination at block 230 indicates a need to adjust the inflator flow rate level, the flow rate may be adjusted to the desired level, and a second determination is made at block 240 to determine whether the occupant characteristics and the adjusted inflator flow rate level dictate an adjustment of the steering wheel angle and/or extension. If no adjustment to the steering wheel angle or extension is required, the process terminate.

If the determination at block 240 indicates a need to adjust the steering wheel position, the appropriate adjustment is determined (block 250). As indicated above with reference to FIG. 1, the adjustment may include adjustment of the steering wheel angle and/or the extension. Thus, the steering wheel is automatically set at a safe position for the driver.

In one embodiment, the adjustments to the steering wheel position are made each time the occupant seats himself in the vehicle. Adjustments may be made thereafter on a regular basis to accommodate a driver who tends to shift sitting positions during a long drive, for example.

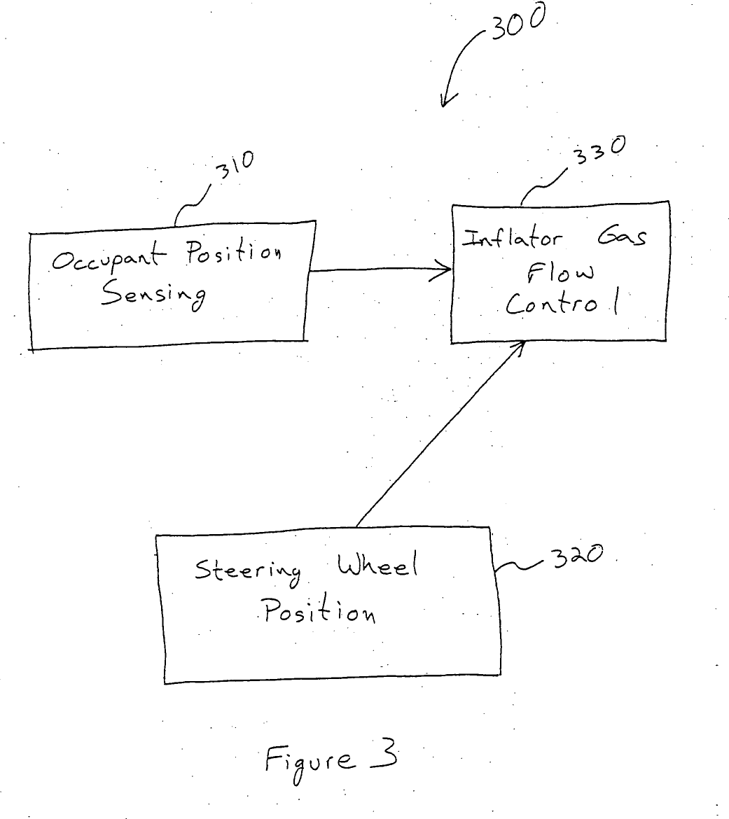

FIG. 3 illustrates an embodiment of a safety restraint control system according to the present invention. In certain cases, an occupant may manually adjust the steering wheel to a position that is comfortable or otherwise desirable for the occupant. In this regard, the safety restraint control system adjusts the inflator gas flow rate to a safe level.

In this embodiment, the safety restraint control system 300 includes an occupant sensing module 310 and similar to that described above with reference to FIG. 1. The occupant sensing module 310 communicates occupant characteristics to an inflator gas flow control module 330. A steering wheel position module 320 is provided to determine the current position of the steering wheel. As noted above, the position of the steering wheel may include the steering wheel angle and the extension. The steering wheel position module 320 communicates information relating to the steering wheel position to the inflator gas flow control module 330.

The inflator gas flow control module 330 then adjusts the gas flow rate at a level based on the occupant characteristics received from the occupant sensing module 310 and the steering wheel position module 320. As an example, if the occupant characteristics indicate an occupant smaller than the fifth-percentile adult female, and the steering wheel position information indicates that the driver has positioned the steering unusually close to his/her face (i.e., large extension), the gas flow rate may be adjusted to compensate for both the size of the occupant and the proximity of the steering wheel to the head of the occupant.

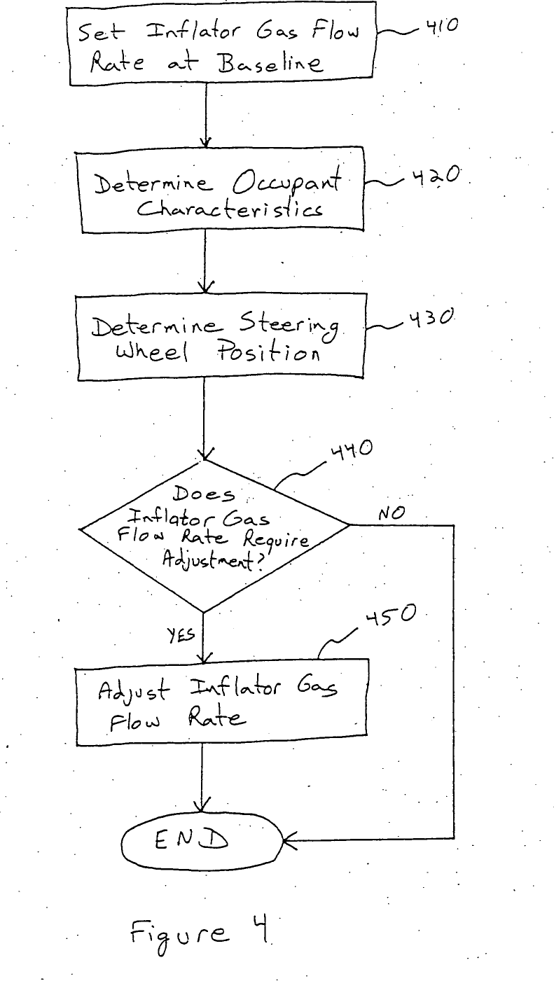

FIG. 4 illustrates the adjustment of the inflator gas flow rate according to an embodiment of the invention. Initially, at block 410, the inflator gas flow rate may be set at a baseline level determined, for example, to be applicable to a majority of the population. At block 420, the occupant characteristics of the occupant of the driver seat are determined. As noted above, the occupant characteristics may include, without limitation, the weight of the occupant and the height of the head of the occupant. At block 430, the steering wheel position (e.g., weight of the occupant, height of the head of the occupant, etc.) is determined.

At block 440, a determination is made as to whether the occupant characteristics and the steering wheel position dictate an adjustment of the inflator flow rate level. As described above, the required flow rate level may be determined through a table lookup or a set of polynomials and may be either continuous or discrete. If no adjustment is required, the process terminates.

If the determination at block 440 dictates an adjustment of the inflator gas flow rate, the appropriate adjustment is determined (block 450) and is applied during an airbag-deployment event. Thus, improved safety may be achieved despite the occupant's manual adjustment of the steering wheel to an otherwise unsafe position.

The adjustments to the inflator gas flow rate may be made each time the occupant seats himself in the vehicle. Adjustments may be made thereafter on a regular basis to accommodate a driver who tends to shift sitting positions during a long drive, for example.

In addition to, or in place of, adjustments to the steering wheel angle and extension, other vehicle settings may be adjusted in response to the determined occupant characteristics. For example, the position or shape of the vehicle seat, seat cushion or seat back may be correspondingly adjusted. Further, the side view and rear view mirrors may be adjusted according to the determined occupant characteristics.

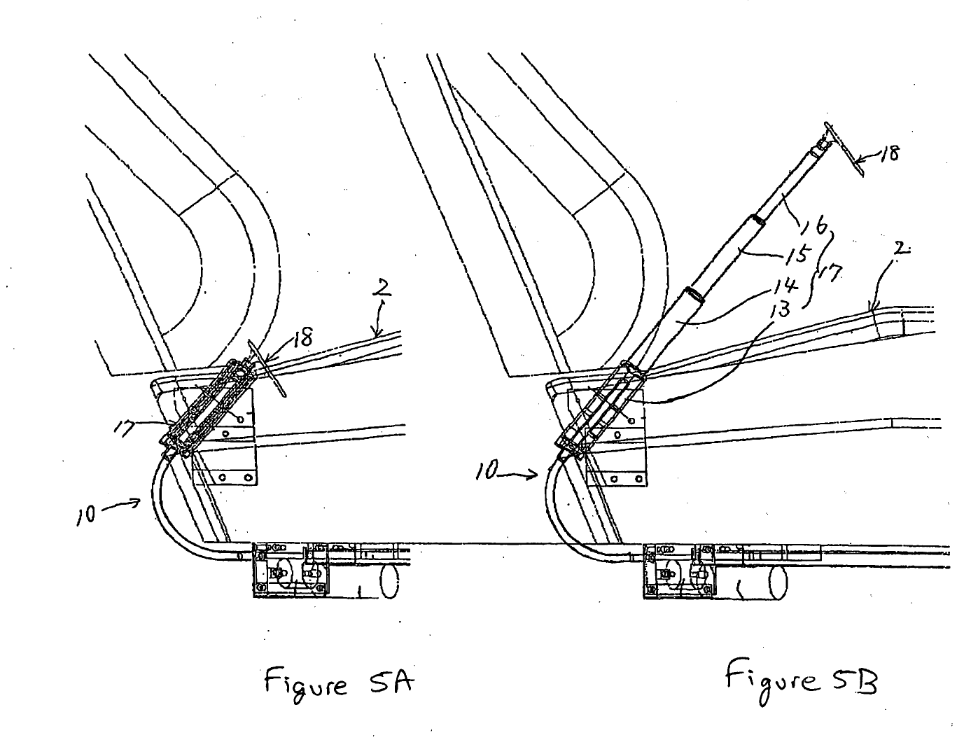

In other embodiments, the various components of a seatbelt mechanism may be appropriately adjusted. For example, FIGS. 5A and 5B illustrate an embodiment of a belt reacher system for adjustment of a seatbelt buckle, or tongue, position. FIGS. 5A and 5B illustrate the belt reacher system 10 in a retracted position and an extended position, respectively. The reacher system 10 is mounted on or adjacent to a vehicle seat 2 adapted to accommodate a passenger or driver therein. The belt reacher system 10 includes an extension module 17 adapted to position a seatbelt tongue 18 for easy access by the occupant of the seat 2. In this regard, when the occupant sits in the seat 2, the sensor module determines the occupant characteristics and causes the belt reacher system 10 to accordingly position the tongue 18. In this regard, the extension module 17 is provided with a housing 13 from which one or more extension may protrude. In the illustrated embodiment, three extensions 14, 15, 16 protrude serially from the housing 13 to position the tongue 18 for easy access by the occupant. Once the occupant removes the tongue from the extension module 17 and engages the tongue 18 with a buckle (not shown), the extension module 17 may return to its retracted position, as shown in FIG. 5A.

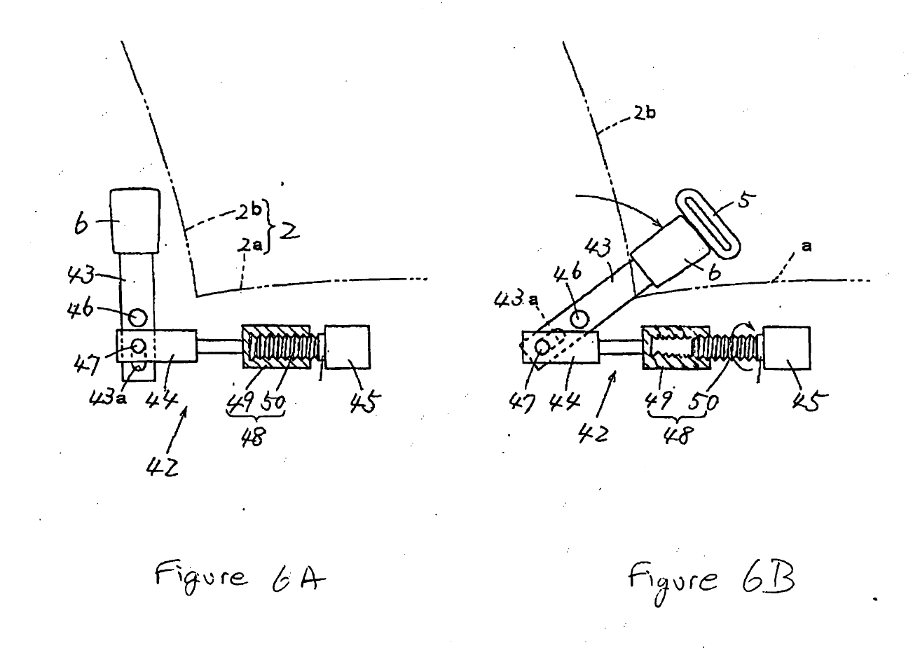

FIGS. 6A and 6B illustrate an embodiment of a belt buckle positioning system for moving a belt buckle between an engaged and a disengaged position. In this regard, the belt buckle positioning system 42 is provided with a buckle 6 adapted to engage a tongue 5 (FIG. 6B). The belt buckle positioning system 42 includes a buckle 6 mounted on a buckle bar 43 which is adapted to pivot about a pivot point 46. The buckle bar 43 includes an opening 43a for engaging a drive bar 44 with a connector pin 47. The drive bar 44 is connected to a drive assembly 48 driven by a motor 45. In response to the determination of occupant characteristics while the buckle 6 is in a disengaged position (FIG. 6A), the motor 45 may be actuated to drive the screw assembly 48. As the screw assembly 48 is driven, a screw 50 of the screw assembly 48 causes a drive block 49 to extend toward the drive bar 44 and to drive the drive bar 44. As the drive bar 44 is driven, the buckle bar 43 rotates about the pivot point 46, causing the buckle 6 to be positioned in the engaged position (FIG. 6B). The amount of rotation of the buckle bar 43 and, thus, the engaged position, may be determined according to the determined occupant characteristics.

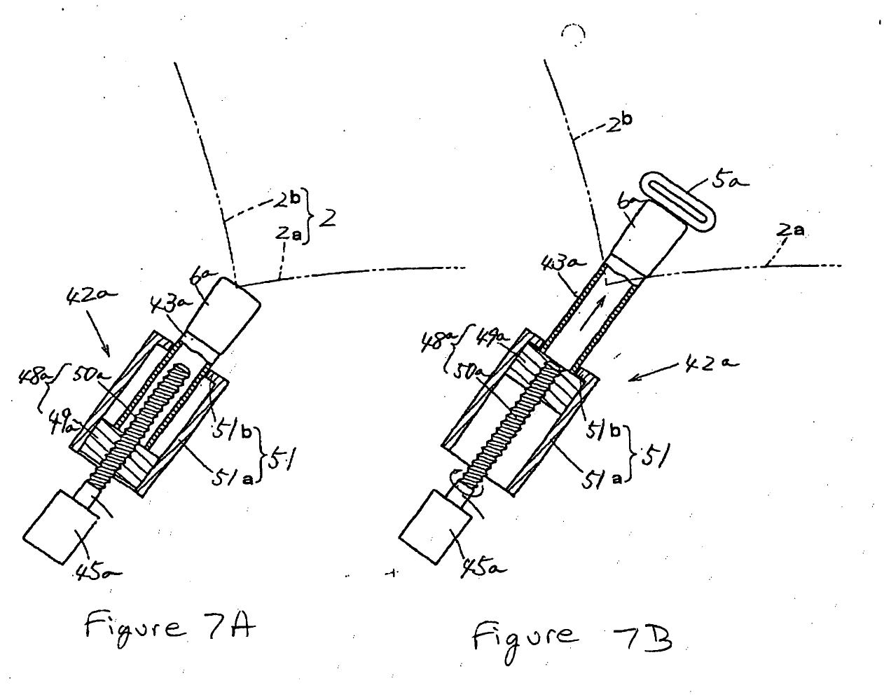

FIGS. 7A and 7B illustrate another embodiment of belt buckle positioning system for moving a belt buckle between an engaged and a disengaged position. In this regard, the belt buckle positioning system 42a is provided with a buckle 6a adapted to engage a tongue 5 (FIG. 7B). The belt buckle positioning system 42a includes a buckle 6a mounted on a buckle bar 43a which is adapted to extend and retract between a disengaged position (FIG. 7A) and an engaged position (FIG. 7B). The buckle bar 43a is connected to a drive assembly 48a driven by a motor 45a. In response to the determination of occupant characteristics while the buckle 6a is in a disengaged position (FIG. 7A), the motor 45a may be actuated to drive the screw assembly 48a. As the screw assembly 48a is driven, a screw 50a of the screw assembly 48a causes a drive block 49a to extend toward the buckle bar 43a and to drive the buckle bar 43a. As the buckle bar 43a is driven, the buckle 6a is extended into the engaged position (FIG. 7B). The amount of extension of the buckle bar 43a and, thus, the engaged position, may be determined according to the determined occupant characteristics.

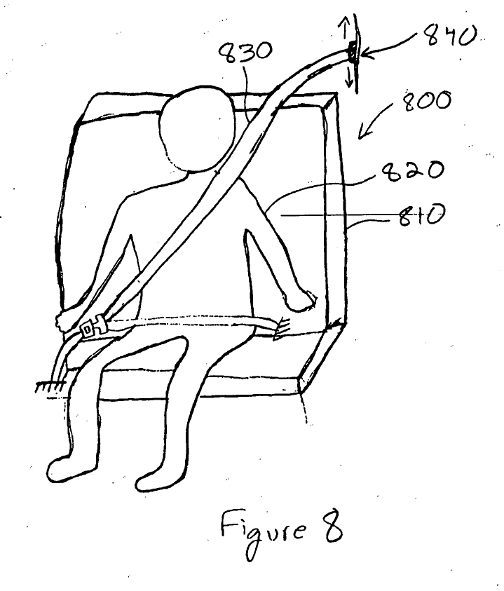

FIG. 8 illustrates an embodiment of a seatbelt height adjustment system for use with embodiments of the present invention. The seatbelt height adjustment system 800 is positioned for use by an occupant 820 in a vehicle seat 810. The occupant 820 is secured in the seat 810 by a seatbelt including a shoulder belt 830. Once the occupant 820 is seated in the vehicle seat 810, occupant characteristics may be determined according to the sensors described above. Based on the determined occupant characteristics, the vertical position of an anchor 840 of the shoulder belt may be adjusted, thereby adjusting the height of the shoulder belt 830.

The term module is used in describing certain embodiments to refer to certain aspects of the invention. A module may be a software, firmware or hardware component. Further, it will be understood by those skilled in the art that the functions performed by the various modules can be combined into one or more modules. For example, the functions performed by a single module may be divided to be performed by two or more modules, and the functions performed by two or more modules may be combined to be performed by a single module.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1-14. (canceled)

15. A steering wheel positioning system for a vehicle, comprising:
an occupant characteristics sensing module adapted to determine characteristics of an occupant in a seat facing a steering wheel;
an inflator control module adapted to adjust inflator gas flow rate to an airbag in the steering wheel based on said occupant characteristics; and
a steering wheel control module adapted to position said steering wheel based on said occupant characteristics and said inflator gas flow rate.

16. The system of claim 15, wherein the occupant characteristics include one or more of the weight of the occupant and the position of the head of the occupant.

17. The system of claim 15, wherein the inflator control module is adapted to adjust inflator gas flow rate on a continuous scale based on occupant characteristics.

18. The system of claim 15, wherein the inflator control module is adapted to adjust inflator gas flow rate at discrete levels based on occupant characteristics.

19. The system of claim 18, wherein the inflator control module is adapted to reduce inflator gas flow rate when the occupant is determined to be smaller than a fifth-percentile adult female.

20. The system of claim 15, wherein the steering wheel control module is adapted to adjust a steering wheel angle.

21. The system of claim 20, wherein the steering wheel control module is adapted to adjust a steering extension position.

22. The system of claim 15, wherein the steering wheel control module is adapted to adjust a steering extension position.

23. The system of claim 15, further comprising:
a vehicle seat control module for adjusting at least one of a position or shape of at least one of a vehicle seat, a seat cushion and a seat back according to determined occupant characteristics.

24. The system of claim 15, further comprising:
a mirror control module for adjusting a position of at least one of a side view mirror and a rear view mirror according to determined occupant characteristics.

25. The system of claim 15, further comprising:
a seatbelt control module for adjusting a seatbelt height of a shoulder belt according to determined occupant characteristics.

26. The system of claim 15, further comprising:
a seatbelt control module for moving at least one of a seatbelt tongue and a seatbelt buckle into an engaging position, the engaging position being determined according to the sensed occupant characteristics.

27. The system of claim 15, wherein the occupant characteristics sensing module includes at least one of a seat weight sensor, an image recognition sensor and an electric capacity sensor.

28. The system of claim 27, wherein the image recognition sensor includes at least one of a CCD camera, a CMOS camera, a 3D camera and a stereo camera.

29-42. (canceled)

43. A safety restraint control system for a vehicle, comprising:
an occupant characteristics sensing module adapted to determine characteristics of an occupant in a seat facing a steering wheel;
a steering wheel position module adapted to determine a position of the steering wheel; and
an inflator control module adapted to adjust inflator gas flow rate to an airbag in the steering wheel based on said occupant characteristics and said position of the steering wheel.

44. The system of claim 43, wherein the occupant characteristics include one or more of the weight of the occupant and the position of the head of the occupant.

45. The system of claim 43, wherein the inflator control module is adapted to adjust inflator gas flow rate on a continuous scale.

46. The system of claim 43, wherein the inflator control module is adapted to adjust inflator gas flow rate at discrete levels.

47. The system of claim 46, wherein the inflator control module is adapted to reduce inflator gas flow rate when the occupant is determined to be smaller than a fifth-percentile adult female.

48. The system of claim 43, wherein the steering wheel position module is adapted to determine a steering wheel angle.

49. The system of claim 48, wherein the steering wheel position module is adapted to determine a steering extension position.

50. The system of claim 43, wherein the steering wheel position module is adapted to determine a steering extension position.

51. The system of claim 43, further comprising:
a vehicle seat control module for adjusting at least one of a position or shape of at least one of a vehicle seat, a seat cushion and a seat back according to determined occupant characteristics.

52. The system of claim 43, further comprising:
a mirror control module for adjusting a position of at least one of a side view mirror and a rear view mirror according to determined occupant characteristics.

53. The system of claim 43, further comprising:
a seatbelt control module for adjusting a seatbelt height of a shoulder belt according to determined occupant characteristics.

54. The system of claim 43, further comprising:
a seatbelt control module for moving at least one of a seatbelt tongue and a seatbelt buckle into an engaging position, the engaging position being determined according to the sensed occupant characteristics.

55. The system of claim 43, wherein the occupant characteristics sensing module includes at least one of a seat weight sensor, an image recognition sensor and an electric capacity sensor.

56. The system of claim 55, wherein the image recognition sensor includes at least one of a CCD camera, a CMOS camera, a 3D camera and a stereo camera.
